(19) United States
(12) Patent Application Publication
(10) Pub. No.: US 2014/0208838 A1
(43) Pub. Date: Jul. 31, 2014

(54) MICRO ELECTRO MECHANICAL SYSTEM CATALYTIC COMBUSTIBLE GAS SENSOR USING POROUS MEMBRANE EMBEDDED MICRO-HEATER

(71) Applicant: Electronics and Telecommunications Research Institute, Daejeon (KR)

(72) Inventors: Seung Eon MOON, Daejeon (KR); Jae Woo LEE, Daejeon (KR); Hyung-Kun LEE, Daejeon (KR); Nak Jin CHOI, Daejeon (KR); Woo Seok YANG, Daejeon (KR); Jong Dae KIM, Daejeon (KR)

(73) Assignee: Electronics and Telecommunications Research Institute, Daejeon (KR)

(21) Appl. No.: 13/897,293

(22) Filed: May 17, 2013

(30) Foreign Application Priority Data
Jan. 29, 2013 (KR) 10-2013-0009883

(51) Int. Cl. G01M 15/10

(52) U.S. Cl. CPC G01M 15/102
USPC 73/114.75

(57) ABSTRACT

Provided is a catalytic combustible gas sensor using a porous membrane embedded micro-heater and a micro electro mechanical system (MEMS) technology. The present disclosure provides a gas sensor that is structurally, mechanically, and electrically stable, and has a simple device fabrication process in a MEMS catalytic combustible gas sensor that is miniaturized and also consumes a significantly small amount of power by puncturing a plurality of holes in membranes, a heating resistor, and a sensing electrode, by etching and thereby thermally isolating a substrate by a predetermined thickness through the plurality of holes, and by including a sensing structure formed using a sensing material and a compensation structure formed using a compensation material.

### CROSS-REFERENCE TO RELATED APPLICATIONS

This application is based on and claims priority from Korean Patent Application No. 10-2013-0009883, filed on Jan. 29, 2013, with the Korean Intellectual Property Office, the disclosure of which is incorporated herein in its entirety by reference.

### TECHNICAL FIELD

The present disclosure relates to a micro electro mechanical system (MEMS) catalytic combustible gas sensor, and more particularly, to a catalytic combustible gas sensor using a porous membrane embedded micro-heater and a MEMS technology.

### BACKGROUND

Research on a gas sensor has been conducted for a long period of time. Currently, various types of gas sensors, such as an optical type, an electrochemical type, a semiconductor type, a catalytic combustion type, and a surface acoustic wave (SAW) type, have been commercialized. Compared to an optical gas sensor or an electrochemical gas sensor that measures a change in a spectrum of gas desired to be measured or conductivity by ion mobility, or a semiconductor type gas sensor or a SAW type gas sensor that measures a change in conductivity by oxidation/reduction reaction, which occurs due to gas absorbed into a sensing material, or a change in a transmission speed of surface wave by the observed gas, a catalytic combustion type that determines presence and concentration of combustible gas has been generally widely used for a combustible sensing element of methane series such as liquefied propane gas (LPG)/liquefied natural gas (LNG). Here, the catalytic combustion type measures a change in a temperature by combustion heat that occurs through gas that is a detection target and a reaction to the sensing material.

FIG. 1 is a circuit diagram of a combustible gas sensing module 100 using a catalytic combustible gas sensor according to the related art.

As illustrated in FIG. 1, the combustible gas sensing module 100 includes a direct power (DC) power source 110, variable resistance (Rv) 120, fixed resistance R1 131, fixed resistance R2 132, a sensing element (Rd) 141, and a compensation element (Rc) 142.

The combustible gas sensing module 100 using the catalytic combustible gas sensor is generally configured as a Wheatstone bridge circuit as illustrated in FIG. 1. Output voltage Vo indicates voltage between a position at which the sensing element (Rd) 141 and the compensation element (Rv) 142 are connected and the variable resistance (Rv) 120. The catalytic combustible gas sensor includes a pair of the sensing element (Rd) 141 that is prepared by adding an oxidation catalyst of a precious metal such as platinum or palladium and the inactive compensation element (Rc) 142 in which a catalyst is not added to prevent oxidation of combustible gas.

The combustible gas sensing module 100 corrects the variable resistance (Rv) 120 so that the output voltage Vo may become “0”, using a characteristic of the

Wheatstone bridge circuit. When combustible gas is injected, a change occurs in a temperature due to combustion through a reaction between gas and a sensing material. Accordingly, due to the change in resistance, balance of the Wheatstone bridge circuit becomes lost in the combustible gas sensing module 100 and Vo, not “zero”, occurs. This value is dependent on catalytic performance of the sensing material, thermal capacity of the sensing element (Rd) 141, and concentration of the combustible gas.

In a method of fabricating a catalytic combustible gas sensor according to the related art, there is a bulk catalytic combustible gas sensor that includes, on a substrate such as alumina or quartz, a sensing material, a sensing electrode, and a heater for increasing an operation temperature for sensing characteristic improvement, or a micro electro mechanical system (MEMS) catalytic combustible gas sensor that is generally similar to the bulk catalytic combustible gas sensor, but decreases an amount of power consumed by removing and thereby thermally isolating a heater portion using etching.

The bulk catalytic combustible gas sensor is strong against a sudden impact, but has a disadvantage in that it consumes a large amount of power in order to maintain a high operation temperature for sensing characteristic improvement and thus, has difficulty in being applied to a portable terminal or a sensor node for a ubiquitous sensor node (USN) service. The exiting MEMS catalytic combustible gas sensor has an advantage in that it consumes a significantly small amount of power compared to the bulk catalytic combustible gas sensor by etching and thereby thermally isolating a substrate (generally, silicone) of a heating resistor portion. This method is divided into a bulk micromachining method of etching a substrate formed on the rear surface of membranes and a heating resistor portion, excluding the membranes and the heating resistor portion, and a surface micromachining method of etching only a portion of the substrate formed on the rear surface of the membranes and the heating resistor portion, excluding a portion of the membranes and the heating resistor portion. In the case of the first method, the membranes are connected to the substrate without having a punctured portion and thus, have relatively mechanical rigidity, but need to be etched by a thickness of the substrate. Accordingly, the first method has a disadvantage in that process cost increases. In the case of the second method, only a portion of the substrate thickness of the rear surface, excluding a portion of the membranes and the heating resistor portion, is etched and thus, process cost is relatively inexpensive. Since the rear surface of the substrate is closed, it is easy to treat a device. However, the membranes are connected to the substrate in a state with having a punctured portion and thus, the second method has a relatively weak structural characteristic. However, both methods have a disadvantage of being relatively weak against a sudden impact.

However, in order to be mounted onto a portable terminal or a ubiquitous sensor terminal, and thereby be used for various services, there is a need for a MEMS catalytic combustible gas sensor that consumes a possibly small amount of power and is structurally, mechanically, and electrically stable even against a sudden impact.

### SUMMARY

The present disclosure has been made in an effort to provide a gas sensor that is structurally, mechanically, and electrically stable, and has a simple device fabrication process in a micro electro mechanical system (MEMS) catalytic combustible gas sensor that is miniaturized and also consumes a significantly small amount of power by puncturing a plurality of holes in membranes, a heating resistor, and a sensing electrode, by etching and thereby thermally isolating a substrate by a predetermined thickness through the plurality of holes, and by including a sensing structure formed using a sensing material and a compensation structure formed using a compensation material.

The present disclosure also provides a catalytic combustible gas sensor that may provide a service in various environments.

Other objects of the present disclosure may be verified from the following description and exemplary embodiments of the present disclosure.

An exemplary embodiment of the present disclosure provides a MEMS catalytic combustible gas sensor, the gas sensor including a first membrane having a plurality of holes; a substrate positioned on the bottom surface of the first membrane and of which a center area is etched by a predetermined thickness in order not to contact with a portion of the bottom surface; a heating resistor formed on a center area of the top surface of the first membrane and having a plurality of holes; a second membrane formed on the first membrane and the heating resistor, and having a plurality of holes; a sensing electrode formed on a center area of the top surface of the second membrane, and having a plurality of holes; at least one sensing structure formed using a gas sensing material on the sensing electrode; and at least one compensation structure formed using a compensation material on the sensing electrode.

According to the exemplary embodiments of the present disclosure, it is possible to configure a MEMS catalytic combustible gas sensor that consumes a relatively small amount of power and is also structurally, mechanically, and electrically stable against a sudden impact, such as a bulk catalytic combustible gas sensor and a MEMS micro-heater configured through existing bulk or surface micro-machining, by puncturing a plurality of holes in membranes and a heating resistor portion, and by overall or partially etching and thereby isolating the rear surface of the membranes and the heating resistor portion by a predetermined thickness through the plurality of holes, or by supporting the membranes, thereby increasing sensor lifespan.

According to the exemplary embodiments of the present disclosure, the MEMS catalytic combustible gas sensor may be mounted onto various systems (for example, a portable terminal or a sensor node), thereby enabling various services to be provided even in extreme situations.

According to the exemplary embodiments of the present disclosure, due to a low power characteristic, the MEMS catalytic combustible gas sensor may be used for long hours even with limited battery capacity and may be stably driven even in various environments in which an energy conversion element such as a thermoelectric element and a piezoelectric element operates, and thereby be driven using a self-powering power source.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a circuit diagram of a combustible gas sensing module embedded with a catalytic combustible gas sensor according to the related art.

FIG. 2 is an exploded perspective view of a micro electro mechanical system (MEMS) catalytic combustible gas sensor including a single a sensing structure and a single compensation structure according to a first exemplary embodiment of the present disclosure.

FIG. 3 is a perspective view of the MEMS catalytic combustible gas sensor including a single sensing structure and a single compensation structure, in which the respective constituent portions of FIG. 2 are assembled.

FIG. 4 is an exploded perspective view of a MEMS catalytic combustible gas sensor including a single sensing structure and a single compensation structure according to a second exemplary embodiment of the present disclosure.

FIG. 5 is a perspective view of the MEMS catalytic combustible gas sensor in a structure of having a column for supporting a membrane, in which the respective constituent portions of FIG. 4 are assembled.

FIGS. 6 to 12 are cross-sectional views of a fabrication process of a structure within a MEMS catalytic combustible gas sensor according to an exemplary embodiment of the present disclosure.

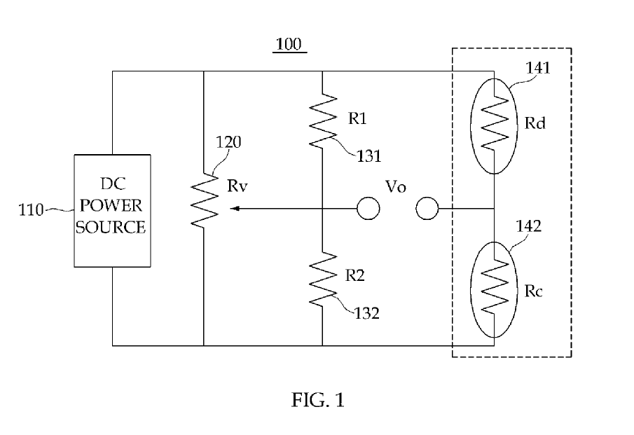

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

When it is determined detailed description related to a related known function or configuration they may make the purpose of the present disclosure unnecessarily ambiguous in describing the present disclosure, the detailed description will be omitted here. Terms used herein are defined to appropriately describe the exemplary embodiments of the present disclosure and thus may be changed depending on a user, the intent of an operator, or a custom. Accordingly, the terms must be defined based on the following overall description of this specification.

As described above, a catalytic combustible gas sensor used in the related art has a disadvantage in that it consumes a large amount of power or is structurally weak despite of excellent sensitivity and thus, has a problem in that it is limitative to be used for a portable terminal or a sensor node for a ubiquitous service network (USN) service.

Accordingly, to solve the above problem, the present disclosure provides a micro-heater that consumes a relatively small amount of power and is structurally and mechanically stable by puncturing a plurality of holes in membranes and a heating resistor portion and by etching and thereby thermally isolating a substrate by a predetermined thickness of the substrate through the plurality of holes, and a micro electro mechanical system (MEMS) catalytic combustible gas sensor using the micro-heater.

Such catalytic combustible gas sensor provided by the present disclosure has an advantage in that it has a low power consumption characteristic and is structurally and mechanically stable.

Hereinafter, exemplary embodiments of the present disclosure will be described in detail with reference to the accompanying drawings.

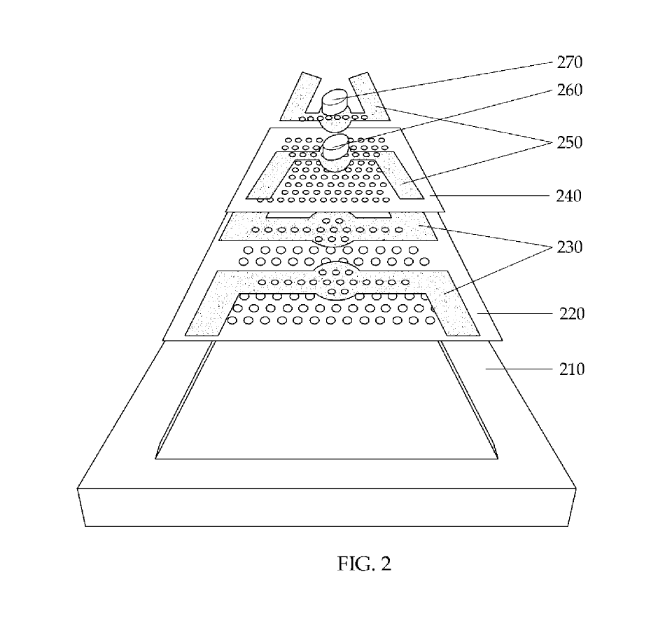

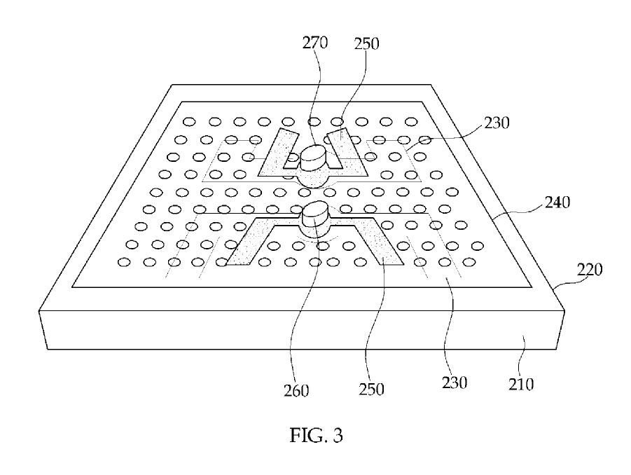

FIG. 2 is an exploded perspective view of a MEMS catalytic combustible gas sensor including a single a sensing structure and a single compensation structure according to a first exemplary embodiment of the present disclosure, and FIG. 3 is a perspective view of the MEMS catalytic combustible gas sensor including a single sensing structure and a single compensation structure, in which the respective constituent portions of FIG. 2 are assembled.

As illustrated in FIG. 2, the MEMS catalytic combustible gas sensor according to the first exemplary embodiment of the present disclosure includes a single sensing structure and a single compensation structure. Even though each of the sensing structure and the compensation structure is configured as “one” in FIG. 2, it is not limited to “one”. That is, the MEMS catalytic combustible gas sensor according to the first exemplary embodiment of the present disclosure may include at least one sensing structure and at least one compensation structure.

Here, the sensing structure includes a first membrane 220 having a plurality of holes, a substrate 210 positioned on the bottom surface of the first membrane 220 and of which a center area is overall or partially etched by a predetermined thickness so that the bottom surface of the first membrane 220 may be exposed, a heating resistor 230 formed on a center area of the top surface of the first membrane 220, required for an operation of a catalytic combustible gas sensor, and having a plurality of holes, a second membrane 240 formed on the first membrane 220 and the heating resistor 230 to cover the heating resistor 230 and having a plurality of holes, a sensing electrode 250 formed on a center area of the top surface of the second membrane 240 and having a plurality of holes, and a gas sensing material 260 formed on the sensing electrode 250. Depending on cases, at least one sensing structure may also include a protecting layer, formed using a nonconductive material, in a remaining portion excluding a portion in which the gas sensing material 260 is to be positioned in the sensing electrode 250 portion.

The compensation structure includes the first membrane 220, the substrate 210 of which the center area is overall or partially etched by a predetermined thickness so that the bottom surface of the first membrane 220 may be exposed, the heating resistor 230 formed on the center area of the top surface of the first membrane 220, required for an operation of the catalytic combustible gas sensor, and having a plurality of holes, the second membrane 240 formed on the first membrane 220 and the heating resistor 230 to cover the heating resistor 230 and having a plurality of holes, the sensing electrode 250 formed on the center area of the top surface of the second membrane 240 and having a plurality of holes, the sensing electrode 250 formed on the center area of the top surface of the second membrane 240 and having a plurality of holes, and a compensation material 270 formed on the sensing electrode 250.

Specifically referring to the respective constituent elements, the substrate 210 may use a silicone substrate used for a general semiconductor process, and may also use a flexible substrate such as aluminum oxide (Al₂O₃), magnesium oxide (MgO), quartz, gallium-nitride (GaN), gallium-arsenic (GaAs) or polycarbonate (PC), polyethyleneterephthalate (PET), polyethersulfone (PES), polyehtylene naphthalate (PEN), and polyimide (PI).

The first membrane 220 may include a single or a plurality of silicon oxide films or nitride silicon films, and may be formed using thermal oxidation deposition, sputtering deposition, or chemical vapor deposition. The first membrane 220 functions to structurally support a micro-heater, and to protect the heating resistor 230 portion when etching the substrate 210. A plurality of holes is punctured in the first membrane 220, and the holes are generally patterned through a photolithography process and an etching process, and are used for etching the substrate 210.

The heating resistor 230 functions to increase an ambient temperature for gas sensing characteristic improvement. A plurality of holes is punctured in the heating resistor 230, and the holes are generally patterned through a photolithography process and an etching process, and are used for etching the substrate 210. The heating resistor 230 may be formed using a metal such as gold (Au), tungsten (W), platinum (Pt), and palladium (Pd), silicone, or conductive metal oxide. The heating resistor 230 is formed on a membrane of a center area of the substrate 210, and may be formed using sputtering deposition, electron beam (e-beam) deposition, or evaporation deposition.

Meanwhile, in order to further increase an adhesive force when forming the heating resistor 230, an adhesive layer (not shown) using chrome (Cr) or titanium (Ti), may be further formed on the membrane. The adhesive layer may be formed using sputtering deposition, e-beam deposition, or evaporation deposition. The heating resistor 230 may be connected to an external circuit (not shown) by a heater electrode pad or a bonding wire.

The second membrane 240 may include a single or a plurality of silicon oxide films or nitride silicon films, and may be formed using thermal oxidation deposition, sputtering deposition, or chemical vapor deposition. The second membrane 240 is positioned between the heating resistor 230 and the sensing electrode 250, and functions to electrically insulate two electrodes and structurally support the micro-heater. A plurality of holes is punctured in the second membrane 240, and the holes are generally patterned through a photolithography process and an etching process and are used for etching the substrate 210.

The sensing electrode 250 outputs, to an outside, a change in a resistance value that occurs according to gas absorption and detachment in the gas sensing material 260. The sensing electrode 250 is formed on the first membrane 220 that is formed on the center area of the substrate 210. A pair of sensing electrodes 250 may be formed to pass the center area of the substrate 210. The sensing electrode 250 is formed in an inter-digital form or a gap form, and may be formed using a metal such as platinum (Pt), aluminum (Al), and gold (Au), or conductive metal oxide, and using sputtering deposition, e-beam deposition, or evaporation deposition. A bonding wire (not shown) for transferring a signal contacts with both ends of the sensing electrode 250.

Depending on cases, a protecting layer using a nonconductive material may also be included in a remaining portion excluding a portion in which the gas sensing material 260 is to be positioned on the top surface of the sensing electrode 250. The protecting layer may be formed as a silicone film or a nitride silicone film, and may be formed using thermal oxidation deposition, sputtering deposition, or chemical vapor deposition.

The gas sensing material 260 is a material for absorbing gas and thereby sensing a change in resistance that occurs according to a change in temperature by combustion heat, and is fabricated by adding a precious metal, such as platinum or palladium, to a material such as metal oxide, carbon nano tube (CNT), and graphene. The compensation material 270 is used without adding a precious metal that functions as a catalyst, and may be formed using sol-gel, electric irradiation, inkjet printing, screen printing, sputtering deposition, or chemical vapor deposition.

The MEMS catalytic combustible gas sensor according to the first exemplary embodiment of the present disclosure constructed as above may have advantages in that it is possible to increase lifespan and operate in various environments by minimizing an amount of power consumed and also minimizing deformation of a membrane regardless of a sudden impact or long driving.

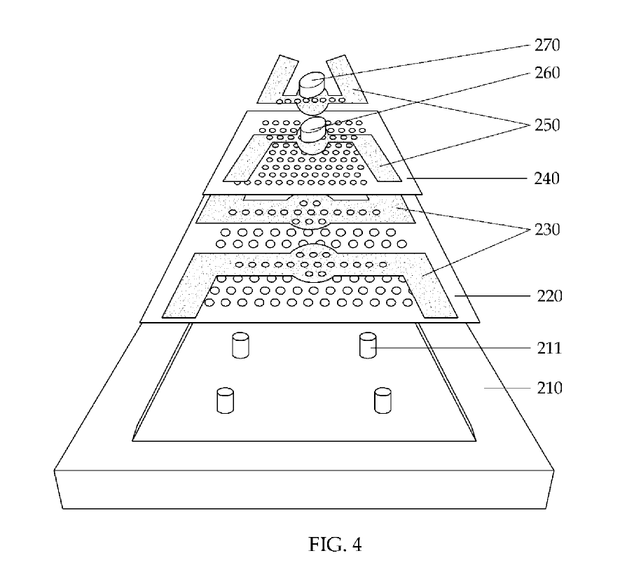

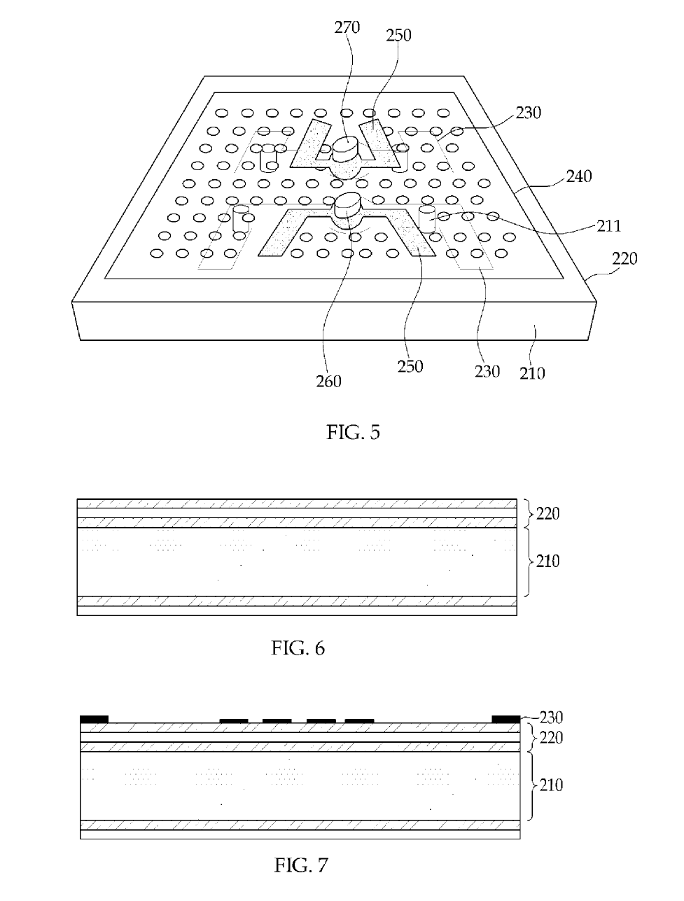

FIG. 4 is an exploded perspective view of a MEMS catalytic combustible gas sensor including a single sensing structure and a single compensation structure according to a second exemplary embodiment of the present disclosure, and FIG. 5 is a perspective view of the MEMS catalytic combustible gas sensor in a structure of having a column for supporting a membrane, in which the respective constituent portions of FIG. 4 are assembled.

A configuration different from the aforementioned configuration of FIG. 2 according to the first exemplary embodiment of the present disclosure is to form columns 211 for supporting membranes by appropriately arranging a plurality of holes and making a portion of the substrate 210 remain when etching the substrate 210 portion positioned below the membranes and the heating resistor 230. As described above, the substrate 210 of which a portion is etched and on which the column 211 is formed may minimize deformation of the membranes even in the case of a sudden impact or a repeated operation, thereby increasing sensor lifespan.

FIGS. 6 to 12 are cross-sectional views of a fabrication process of a structure within a MEMS catalytic combustible gas sensor according to an exemplary embodiment of the present disclosure.

As illustrated in FIG. 6, a single or a plurality of silicon oxide films or nitride oxide films for the first membrane 220 is deposited on the single-side polished silicone substrate 210 using thermal oxidation deposition, sputtering deposition, or chemical vapor deposition.

As illustrated in FIG. 7, a metal film formed using gold (Au), tungsten (W), platinum (Pt), and palladium (Pd), a silicone film, or a conductive metal oxide film for the heating resistor 230 is deposited thereon using sputtering deposition, e-beam deposition, or evaporation deposition, and is patterned through a lithography process as designed.

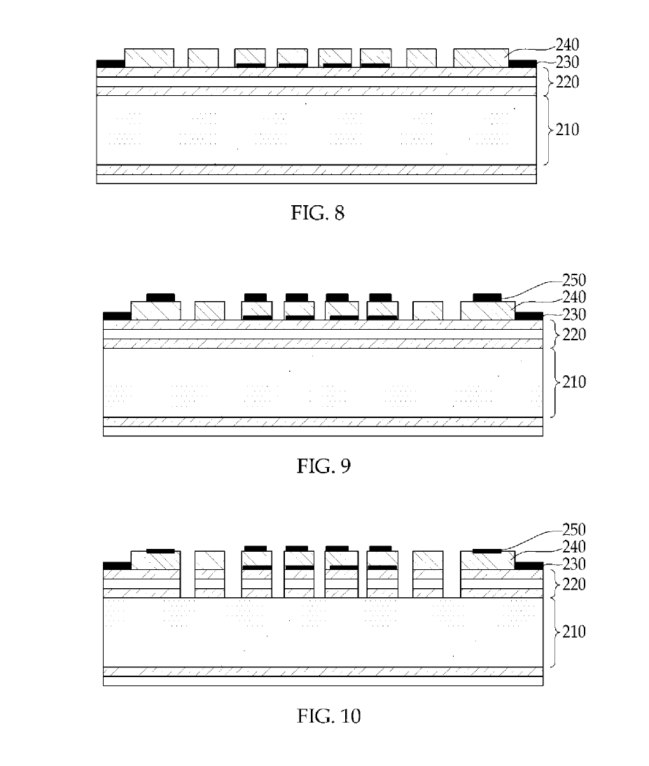

As illustrated in FIG. 8, next, a single or a plurality of silicon oxide films or nitride oxide films for the second membrane 240 is deposited thereon using thermal oxidation deposition, sputtering deposition, or chemical vapor deposition, and is patterned through a lithography process as designed.

As illustrated in FIG. 9, a metal film formed using platinum (Pt), aluminum (Al), or gold (Au), or a conductive metal oxide film for the sensing electrode 250 is deposited thereon using sputtering depositing, e-beam deposition, or evaporation deposition, and is patterned through a lithography process as designed.

As illustrated in 10, to thermally isolate membranes and heating resistor 230 portions from each other, a predetermined thickness portion of the substrate 210 is etched therebelow. Before this, an area to be etched is patterned through a lithography process and an etching process.

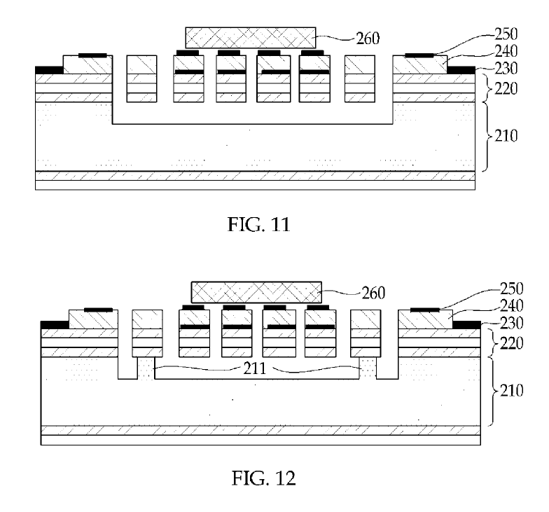

As illustrated in FIG. 11, a substrate etching process is based on an isotropic etching process that needs to perform etching even with respect to the substrate 210 portion that is not exposed through a hole. A method using XeF2 gas is generally used.

Meanwhile, as illustrated in FIG. 12, when etching the substrate 210 the column 211 for supporting the first membrane 220 and the second membrane 240 is formed by etching the substrate 210 excluding a portion of the substrate 210.

Based on deposition of the gas sensing material 260, an order of a process of depositing the gas sensing material 260 and an order of a process of etching the substrate 210 are changed. For example, in the case of applying sensing material deposition of applying pressure to the substrate 210, such as screen printing, the MEMS catalytic combustible gas sensor is fabricated by initially depositing the gas sensing material 260 and then etching a predetermined thickness of silicone. In the case of sensing material deposition of not applying pressure to the substrate 210, such as sol-gel, electric irradiation, inkjet printing, sputtering deposition, and chemical vapor deposition, a predetermined thickness of silicone may be initially etched and the gas sensing material 260 may be later deposited.

Depending on cases, even though not illustrated in FIGS. 6 to 12, a process of depositing and then patterning an insulating film such as SiO2 or SiNx may be added in order to protect a gas sensing electrode.

The present disclosure may provide a gas sensor that is structurally, mechanically, and electrically stable, and has a simple device fabrication process in an? MEMS catalytic combustible gas sensor that is miniaturized and also consumes a significantly small amount of power. In this aspect, the present disclosure is beyond the limits of the existing technology. Accordingly, in addition to applicability to the related art, there is a sufficient probability for marketing and selling a device that is applied with the present disclosure. It is possible to clearly implement the present disclosure in the reality. Accordingly, the present disclosure is the industrially applicable invention.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A catalytic combustible gas sensor, comprising:
a first membrane having a plurality of holes;
a substrate positioned on the bottom surface of the first membrane and of which a center area is etched by a predetermined thickness in order not to contact with a portion of the bottom surface;
a heating resistor formed on a center area of the top surface of the first membrane and having a plurality of holes;
a second membrane formed on the first membrane and the heating resistor, and having a plurality of holes;
a sensing electrode formed on a center area of the top surface of the second membrane, and having a plurality of holes;
at least one sensing structure formed using a gas sensing material on the sensing electrode; and
at least one compensation structure formed using a compensation material on the sensing electrode.

2. The gas sensor of claim 1, wherein the substrate positioned on the bottom surface of the first membrane is etched to have a structure of being overall etched through the plurality of holes that is present in the second membrane, the first membrane, and the heating resistor to thereby have no column for supporting the first membrane.

3. The gas sensor of claim 1, wherein the substrate positioned on the bottom surface of the first membrane is etched to have a structure of being partially etched through the plurality of holes that is present in the second membrane, the first membrane, and the heating resistor to thereby have a column for supporting the first membrane.

4. The gas sensor of claim 1, wherein, on the second membrane and the first membrane, a single or plural silicon oxide films or a nitride silicon film is deposited using any one of thermal oxidation deposition, sputtering deposition, and chemical vapor deposition.

5. The gas sensor of claim 1, wherein, on the heating resistor, a metal film formed using any one of gold (Au), tungsten (W), platinum (Pt), and palladium (Pd), a silicone film, or a conductive metal oxide film, is deposited using any one of sputtering deposition, electron beam deposition, and evaporation deposition.

6. The gas sensor of claim 1, wherein, on the sensing electrode, a metal film formed using any one of platinum (Pt), aluminum (al), and gold (Au), or a conductive metal oxide film is deposited using any one of sputtering deposition, electron beam deposition, and evaporation deposition.

7. The gas sensor of claim 1, wherein:
the gas sensing material is formed by adding platinum (Pt) or palladium (Pd) that is a precious metal to any one of metal oxide, carbon nano tube (CNT), and graphene, and
the compensation material is usable without adding a precious metal that functions as a catalyst, and is deposited using any one of sol-gel, drop coating, screen printing, chemical vapor deposition, and sputtering deposition.

8. The gas sensor of claim 1, wherein the substrate is fabricated using any one of silicone, aluminum oxide (Al₂O₃), magnesium oxide (MgO), quartz, gallium-nitride (GaN), gallium-arsenic (GaAs) or polycarbonate (PC), polyethyleneterephthalate (PET), polyethersulfone (PES), polyehtylene naphthalate (PEN), and polyimide (PI).
